(19) United States
(12) Patent Application Publication
(10) Pub. No.: US 2026/0216695 A1
(43) Pub. Date: Jul. 30, 2026

(54) TANGENTIAL FLOW CONTACTOR ELEMENT

(71) Applicant: Parker-Hannifin Corporation, Cleveland, OH (US)

(72) Inventors: John D. Holland, Lawrenceburg, TN (US); Dean James Derrek Pighin, Thompsons Station, TN (US); Lei Li, Franklin, TN (US); Yogesh J. Ner, Spring Hill, TN (US); Bradley J. Mouser, Culleoka, TN (US); Darrell H. Mann, Fayetteville, TN (US); Jonathan George, Chattanooga, TN (US)

(73) Assignee: Parker-Hannifin Corporation, Cleveland, OH (US)

(21) Appl. No.: 19/573,350

(22) Filed: Mar. 20, 2026

Related U.S. Application Data
(63) Continuation of application No. PCT/US2024/047644, filed on Sep. 20, 2024.
(60) Provisional application No. 63/539,358, filed on Sep. 20, 2023.

(51) Int. Cl. B01J 20/26; B01D 53/04; B01D 53/14; B01J 20/28; B01J 20/30

(52) U.S. Cl. CPC B01J 20/261; B01D 53/0407; B01D 53/1475; B01J 20/28035; B01J 20/28052; B01J 20/28095; B01J 20/3078; B01D 2253/206; B01D 2257/504

(57) ABSTRACT

Disclosed are embodiments of a media for capturing carbon dioxide from a gas stream of ambient air. The media comprises a first fiber substrate and carbon capture particles attached to the first fiber substrate. The carbon capture particles are formed from one or more materials capable of capturing carbon dioxide through absorbance or adsorbance.

### CROSS-REFERENCE TO RELATED PATENT APPLICATIONS

This patent application is a continuation of PCT/US2024/047644, filed

Sep. 20, 2024, which claims the benefit of U.S. Provisional Patent Application No. 63/539,358, filed Sep. 20, 2023, the entire teachings and disclosure of which are incorporated herein by reference thereto.

### FIELD OF THE INVENTION

This invention generally relates to a carbon capture element and, in particular, to a laminated carbon capture media for a tangential flow contactor element.

### BACKGROUND OF THE INVENTION

Reducing carbon dioxide emissions has been an important environmental mission for many years. A variety of promising techniques have been proposed to address the production of carbon dioxide by various processes, including power generation and production of certain products. One emerging technology is carbon capture. During carbon capture, carbon dioxide is removed from a gas stream of environmental air, and the gas stream with a reduced carbon dioxide concentration is released. The captured carbon dioxide is stored, preventing its release into the atmosphere.

### BRIEF SUMMARY OF THE INVENTION

In a first aspect, embodiments of the present disclosure relate to a media for capturing carbon dioxide from a gas stream of ambient air. The media comprises a first fiber substrate and carbon capture particles attached to the first fiber substrate. The carbon capture particles are formed from one or more materials capable of capturing carbon dioxide through absorbance or adsorbance.

In a second aspect, embodiments of the present disclosure relate to the media of the first aspect in which the media further comprises an adhesive. The adhesive attaches the carbon capture particles to the first fiber substrate.

In a third aspect, embodiments of the present disclosure relate to the media of the second aspect in which the adhesive comprises adhesive beads and/or an adhesive layer.

In a fourth aspect, embodiments of the present disclosure relate to the media of the second aspect or the third aspect in which the adhesive and the carbon capture particles are pre-mixed with adhesive that is spread upon the scrim as at least one mixed layer.

In a fifth aspect, embodiments of the present disclosure relate to the media of any of the second aspect to the fourth aspect in which the adhesive comprises bi-component and the adhesive and the carbon capture particles are thermally laminated to the first fiber substrate.

In a sixth aspect, embodiments of the present disclosure relate to the media of any of the second aspect to the fifth aspect in which the adhesive is provided in 2.5% to 30% by weight of the carbon capture particles.

In a seventh aspect, embodiments of the present disclosure relate to the media of any of the first aspect to the sixth aspect in which the media comprises 100 gsm to 1500 gsm of the carbon capture particles.

In an eighth aspect, embodiments of the present disclosure relate to the media of any of the first aspect to the seventh aspect in which the carbon capture particles comprise a maximum cross-sectional dimension in a range from 0.050 mm to 1.5 mm

In a ninth aspect, embodiments of the present disclosure relate to the media of any of the first aspect to the eighth aspect in which the carbon capture particles comprise at least one member of the following group: amine-based particles, zeolites, silica, alumina, metal oxides, metal-organic frameworks (MOFs), activated carbon, graphite, graphene, fullerene, biochar, and/or hydrochar.

In a tenth aspect, embodiments of the present disclosure relate to the media of any of the first aspect to the ninth aspect in which the first fiber substrate is a nonwoven fabric and/or preferably a scrim. The first fiber substrate comprises a fibers of polyester, polyamide, other polyolefins and/or other thermoplastic material, and at least some of the fibers preferably include a polyester. At least some of the fibers preferably are bi-component facilitating thermal lamination.

In an eleventh aspect, embodiments of the present disclosure relate to the media of any of the first aspect to the tenth aspect in which the first fiber substrate comprises one or more of the following characteristics: (a) the fibers forming the first fiber substrate have a diameter in a range of 2μm to 25μm; (b) a thickness in a range of 50μm to 500μm; (c) a basis weight in a range from 10 gsm to 150 gsm; and/or (d) air permeability in a range from 50 cfm to 1200 cfm as measured according to ASTM D737.

In a twelfth aspect, embodiments of the present disclosure relate to the media of any of the first aspect to the eleventh aspect in which the fibers forming the first fiber substrate are hydrophobic having a water contact angle in a range from 100° to 115° as measured according to ASTM D5725-99, thereby providing the media with a quick dry property.

In a thirteenth aspect, embodiments of the present disclosure relate to the media of any of the first aspect to the twelfth aspect in which the media further comprises a second fiber substrate. The carbon capture particles are laminated between the first fiber substrate and the second fiber substrate.

In a fourteenth aspect, embodiments of the present disclosure relate to the media of any of the first aspect to the thirteenth aspect in which the media comprises a plurality of pleats and/or embossments forming flow channels, preferably in the form of elongated flutes.

In a fifteenth aspect, embodiments of the present disclosure relate to the media of the fourteenth aspect in which the plurality of pleats are triangular pleats or sinusoidal pleats having a pleat depth in a range from 2 mm to 25 mm.

In a fifteenth aspect, embodiments of the present disclosure relate to the media of any of the first aspect to the fifteenth aspect in which the media comprises embossing.

In a seventeenth aspect, embodiments of the present disclosure relate to the media of the sixteenth aspect in which the embossing comprises at least one of a plurality of dots, a plurality of triangles, a plurality of chevrons, or a plurality of wavy lines.

In an eighteenth aspect, embodiments of the present disclosure relate to a carbon capture media sheet. The carbon capture media sheet comprises a first media that is pleated and/or embossed and a second media that is flat and/or embossed. The second media is bonded to the first media so as to define a plurality of flow-through channels. At least one of and preferably both of the first media and the second media comprise the media according to any of the first aspect to the seventeenth aspect.

In a nineteenth aspect, embodiments of the present disclosure relate to a carbon capture element that comprises a plurality of the carbon capture media sheets of according to the eighteenth aspect arranged in a stack.

In a twentieth aspect, embodiments of the present disclosure relate to a carbon capture element that comprises the carbon capture media sheet according to the eighteenth aspect wound into a cylinder.

In a twenty-first aspect, embodiments of the present disclosure relate to the carbon capture element of the nineteenth aspect or the twentieth aspect in which the carbon capture element further comprises a frame. The frame comprises an outer ring surrounding the stacked or wound carbon capture media sheet. A first cap is disposed at a first end of the outer ring, and a second cap disposed at a second end of the outer ring opposite to the first end. Alternatively, the frame may just comprise the first cap and the second cap glued to the carbon capture element without the outer ring. In any of the foregoing embodiments, a bolt may extend from the first cap to the second cap through the stacked or wound carbon capture media sheets in order to provide additional structure to the carbon capture element.

In a twenty-second aspect, embodiments of the present disclosure relate to the carbon capture element according to the twenty-first aspect in which the carbon capture element further comprises a gasket extending from the second cap.

In a twenty-third aspect, embodiments of the present disclosure relate to a contactor that comprises one or more carbon capture elements according to any of the nineteenth aspect to the twenty-second aspect.

In a twenty-fourth aspect, embodiments of the present disclosure relate to a contactor according to the twenty-third aspect in which the contactor comprises at least two carbon capture elements that are stacked in an axial direction.

In a twenty-fifth aspect, embodiments of the present disclosure relate to a contactor according to the twenty-fourth aspect in which at least 50% of the flow-through channels of adjacent carbon capture elements of the at least two carbon capture elements are offset in the axial direction.

In a twenty-sixth aspect, embodiments of the present disclosure relate to a contactor according to the twenty-fourth aspect in which the at least two carbon capture elements comprise a first carbon capture element and a second carbon capture element. The flow-through channels of the first carbon capture element are arranged at a negative angle relative to the axial direction, and the flow-through channels of the second carbon capture element are arranged at a positive angle relative to the axial direction.

In a twenty-seventh aspect, embodiments of the present disclosure relate to a contactor according to the twenty-fourth aspect in which at least one of the at least two carbon capture elements comprises an inlet flow face defining a plane that is transverse to the axial direction of stacking.

In a twenty-eighth aspect, embodiments of the present disclosure relate to a contactor according to the twenty-fourth aspect in which the contactor further comprises a screen disposed between each carbon capture element of the at least two carbon capture elements. The screen comprises an outer hoop and a plurality of vanes extending across the outer hoop. The outer hoop is disposed in a first plane, and each vane of the plurality of vanes is disposed in a plane that is transverse to the first plane.

In a twenty-ninth aspect, embodiments of the present disclosure relate to a contactor according to any of the twenty-third aspect to the twenty-eighth aspect in which the contactor comprises three carbon capture elements.

In a thirtieth aspect, embodiments of the present disclosure relate to a method of reducing a concentration of carbon dioxide in a gas stream. In the method, the gas stream having a first concentration of carbon dioxide is flowed through the contactor according to any of the twenty-third aspect to the twenty-ninth aspect from a first side to a second side. Further, in the method, carbon dioxide is absorbed or adsorbed in the media such that a second concentration of the carbon dioxide on the second side of the media is less than the first concentration of carbon dioxide on the first side of the media.

In a thirty-first aspect, embodiments of the present disclosure relate to the method according to the thirtieth aspect in which the gas stream is ambient air and the first concentration of carbon dioxide is in a range of 300 ppm to 500 ppm.

In a thirty-second aspect, embodiments of the present disclosure relate to the method according to the thirty-first aspect in which the second concentration of carbon dioxide is 10 ppm or less.

In a thirty-third aspect, embodiments of the present disclosure relate to the method according to any of the thirtieth aspect to the thirty-second aspect in which the method further comprises flowing steam through the media to cause the carbon dioxide to desorb from the media and storing the desorbed carbon dioxide in a manner that does not release the carbon dioxide to the environment.

In a thirty-fourth aspect, embodiments of the present disclosure relate to a method of preparing a media according to any of the first aspect to the seventeenth aspect. In the method, the carbon capture particles are spread onto the first fiber substrate, and the carbon capture particles are attached to the first fiber substrate.

In a thirty-fifth aspect, embodiments of the present disclosure relate to the method according to the thirty-fourth aspect in which the spreading further comprises spreading adhesive beads onto the first fiber substrate and wherein the attaching further comprises attaching the carbon capture particles to the first fiber substrate with the adhesive beads.

In a thirty-sixth aspect, embodiments of the present disclosure relate to the method according to the thirty-fourth aspect in which the method further comprises providing an adhesive layer over the first fiber substrate prior to or after the spreading and in which the attaching further comprises attaching the carbon capture particles to the first fiber substrate with the adhesive layer.

In a thirty-seventh aspect, embodiments of the present disclosure relate to the method according to any of the thirty-fourth aspect to the thirty-sixth aspect in which the method further comprises laminating a second fiber substrate to the first fiber substrate during the attaching.

In a thirty-eighth aspect, embodiments of the present disclosure relate to the method according to the thirty-seventh aspect in which laminating comprises heating to a temperature in a range from 80° C. to 250° C. and applying a pressure in a range from 10 psi to 70 psi.

In a thirty-ninth aspect, embodiments of the present disclosure relate to the method according to the thirty-seventh aspect or the thirty-eighth aspect in which laminating is performed using a flatbed thermal laminator.

In a fortieth aspect, embodiments of the present disclosure relate to an apparatus for capturing carbon dioxide from a gas stream of ambient air. The apparatus comprises a tangential flow contactor having opposed flow faces, and comprising at least one sheet of porous media that comprises one or more materials capable of capturing carbon dioxide through absorbance or adsorbance. The at least one sheet of porous media is gathered into at least one media element to provide the tangential flow contractor with at least one flow channel transversing between the flow faces for passing the gas stream therebetween. The apparatus further comprises a flow interrupter arranged between the inlet face and the outlet face operable to interrupt flow of the gas stream along the at least one flow channel to diffuse the gas stream into and out of the porous media.

In a forty-first aspect, embodiments of the present disclosure relate to the apparatus according to the fortieth aspect in which the at least one sheet of porous media is pleated and/or embossed defining a plurality of longitudinally extending flutes, the longitudinally extending flutes providing all or a portion of the at least one flow channel.

In a forty-second aspect, embodiments of the present disclosure relate to an apparatus according to the forty-first aspect in which the flow interrupter comprises a plurality of protrusions arranged along the porous media between the opposed flow faces.

In a forty-third aspect, embodiments of the present disclosure relate to an apparatus according to the forty-second aspect in which the protrusions comprise a plurality of embossments formed into the at least one sheet of porous media, the embossments extending transversely relative to the longitudinally extending flutes.

In a forty-fourth aspect, embodiments of the present disclosure relate to an apparatus according to the forty-third aspect in which the flow channels are deeper than the embossments, in which the longitudinally extending flutes have a depth of between 2 mm and 25 mm, and preferably, in which the protrusions have a depth that is between 0.5 mm and less than the depth of the longitudinally extending flutes.

In a forty-fifth aspect, embodiments of the present disclosure relate to an apparatus according to any of the forty-first aspect to the forty-fourth aspect in which the at least one media element includes multiple media elements arranged in fluidic series. Each media element defines a set of the longitudinally extending flutes, and the longitudinally extending flutes of the multiple media elements provide for the at least one flow channel. The flow interrupter comprises flow interruption between adjacent members of the multiple media elements.

In a forty-sixth aspect, embodiments of the present disclosure relate to an apparatus according to the forty-fifth aspect in which adjacent members of the multiple media elements are spaced with a gap therebetween providing an intermediate gas pressure chamber, the flow interrupter comprising the gas pressure chamber.

In a forty-seventh aspect, embodiments of the present disclosure relate to an apparatus according to the forty-fifth aspect or the forty-sixth aspect in which the flow interrupter comprises an offset alignment of the longitudinally extending flutes. The longitudinally extending flutes of adjacent members are misaligned such that at least one flow channel travels a tortuous path.

In a forty-eighth aspect, embodiments of the present disclosure relate to an apparatus according to any of the forty-fifth aspect to the forty-seventh aspect in which the flow interrupter comprises differently angled flutes and in which the longitudinally extending flutes of adjacent members project in different longitudinal directions.

In a forty-ninth aspect, embodiments of the present disclosure relate to an apparatus according to any of the forty-fifth aspect to the forty-eighth aspect in which the flow interrupter comprises at least one baffle interposed between adjacent members.

In a fiftieth aspect, embodiments of the present disclosure relate to an apparatus according to any of the fortieth aspect to the forty-ninth aspect in which the at least one sheet of porous media is gathered into a wound, spiral configuration, and preferably provides axial flow between opposed flow faces.

In a fifty-first aspect, embodiments of the present disclosure relate to an apparatus according to any of the fortieth aspect to the fiftieth aspect in which the at least one sheet of porous media comprises the media according to any of the first aspect to the seventeenth aspect.

In a fifty-second aspect, embodiments of the present disclosure relate to an apparatus for capturing carbon dioxide from a gas stream of ambient air. The apparatus comprises a tangential flow contactor having opposed flow faces, and comprising at least one sheet of porous media that comprises one or more materials capable of capturing carbon dioxide through absorbance or adsorbance. The at least one sheet of porous media is gathered into at least one media element to provide the tangential flow contractor with a plurality of flow channels transversing between the flow faces for passing the gas stream therebetween. The at least one sheet of porous media comprises fibers of a hydrophobic material, thereby providing the media with a quick dry property

In a fifty-third aspect, embodiments of the present disclosure relate to an apparatus according to the fifty-second aspect in which the fibers are hydrophobic having a water contact angle in a range from 100° to 115° as measured according to ASTM D 5725-99.

In a fifty-fourth aspect, embodiments of the present disclosure relate to an apparatus according to the fifty-second aspect or the fifty-third aspect in which the at least one sheet of porous media comprises the media according to any of the first aspect to the seventeenth aspect.

In a fifty-fifth aspect, embodiments of the present disclosure relate to an apparatus according to any of the fifty-second aspect to the fifty-fourth aspect in which the apparatus further comprises the flow interrupter of the apparatus according to any of the fortieth aspect to the fifty-first aspect.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 and 2 schematically depict carbon capture media, according to exemplary embodiments of the present disclosure;

FIGS. 3 and 4 schematically depict media sheets of pleated media, having triangular pleats (FIG. 3) and sinusoidal pleats (FIG. 4) bonded to flat media, according to exemplary embodiments of the present disclosure;

FIGS. 5-7 depict examples of embossing patterns that can be embossed into the carbon capture media, according to exemplary embodiments of the present disclosure;

FIGS. 8 and 9 depict a carbon capture element formed form a wound media sheet disposed within a frame structure, according to exemplary embodiments of the present disclosure;

FIG. 10 depicts a contactor formed from multiple carbon capture elements according to FIGS. 8 and 9 stacked in an axial direction, according to exemplary embodiments of the present disclosure;

FIG. 11 depicts another contactor formed from three of the carbon capture elements according to FIG. 10 disposed within a contactor housing, according to an exemplary embodiment of the present disclosure;

FIGS. 12-17 depict various stacking arrangements and configurations for the carbon capture elements that provide such increased turbulence, according to exemplary embodiments of the present disclosure;

FIGS. 18 and 19 schematically depict external and internal views, respectively, of a carbon capture system, according to an embodiment of the present disclosure; and

FIGS. 20-24 depict examples of carbon capture media, pleated media, media sheet, and carbon capture elements, according to embodiments of the present disclosure

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the present disclosure relate to a carbon capture element, or “contactor,” formed from a laminated carbon capture media. A gas stream, such as environmental air, is directed through the contactor, and carbon in the gas stream is removed by exposure of the gas stream to the laminated carbon capture media. As will be described more fully below, the laminated carbon capture media includes carbon capture particles attached to a fiber substrate or sandwiched between fiber substrates. The laminated media is typically pleated, but also may be simply embossed and wound (or stacked embossed sheets) to form flow-through channels that allow for the passage of the gas stream from an inlet face to an outlet face of the contactor.

Advantageously, the disclosed laminated media can be used with a variety of different carbon capture particles, such as various ceramics, activated carbon, membranes, and ion exchange resins, amongst others. These carbon capture particles can be mixed with binder powder and spread over a fiber substrate, such as a woven or nonwoven scrim, and attached using, e.g., thermal lamination methods. In contrast to certain conventional contactors that have to be recharged with carbon capture material, the presently disclosed contactor can reversibly absorb/adsorb and desorb carbon dioxide for a long time, which may be thousands of cycles before reaching its lifetime. These and other aspects and advantages will be described more fully in relation to the embodiments presented below and shown in the figures. These embodiments are provided by way of illustration and not limitation.

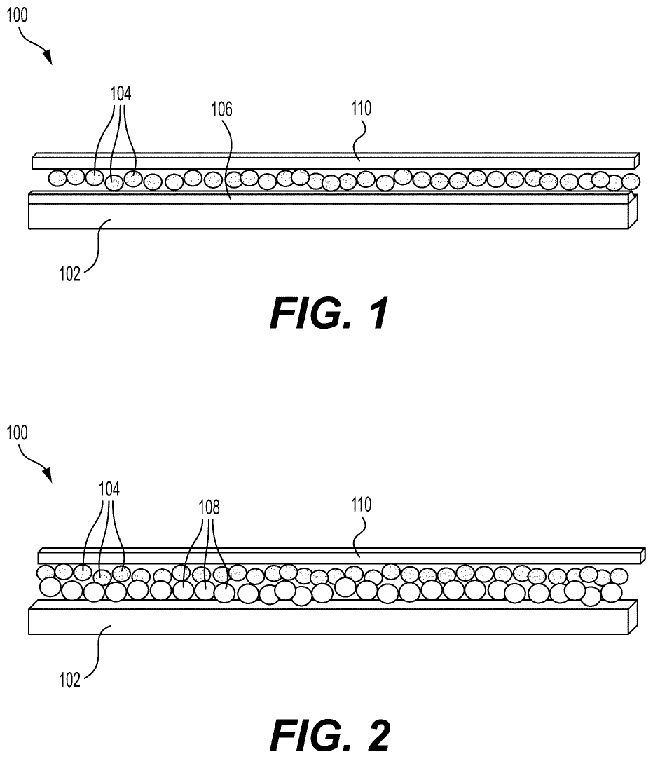

FIGS. 1 and 2 depict embodiments of a carbon capture media 100, which is a porous media, according to embodiments of the present disclosure. Referring first to FIG. 1, the media 100 includes a first fiber substrate 102 (for example a fibrous scrim) to which carbon capture particles 104 are attached. In one or more embodiments, the carbon capture particles 104 are adhered to the first fiber substrate 102, for example by adhesive attachment. In the embodiment shown in FIG. 1, the carbon capture particles 104 are adhered to the first fiber substrate 102 by a layer of adhesive 106. In one or more other embodiments, such as shown in FIG. 2, the carbon capture particles 104 are adhered to the first fiber substrate 102 by adhesive beads 108.

Further, as shown in FIGS. 1 and 2, one or more embodiments of the presently disclosed media 100 include a second fiber substrate 110. In such embodiments, the carbon capture media 104 is disposed between the first fiber substrate 102 and the second fiber substrate 110.

Alternatively or additionally to the adhesive layer 106 and/or adhesive beads 108, in one or more other embodiments, the carbon capture particles 104 are adhered to the first fiber substrate 102 by thermal lamination; for example, binder adhesive (preferably, a bi-component thermoplastic) can be mixed with carbon capture particles 104 and laid over the first fiber substrate 102 and the composite is thermally laminated.

Also, in one or more embodiments, the adhesive may be alternatively or additionally supplied in part or full by the fiber substrate(s) 102, 110; for example. either or both fiber substrates 102, 110 may be a bi-component material in which the low melt component can be melted and used for adhesive attachment of carbon capture particles 104. However, more preferably additional binder beyond a melt component of one or both of the fiber substrates 102, 110 is employed as normally multiple layers of the carbon capture particles 104 are used (and hence additional adhesive mixed with carbon capture particles beyond the scrim material is advantageous in such arrangements).

In one or more embodiments, the first fiber substrate 102 is a nonwoven fabric; however, in one or more other embodiments, the first fiber substrate 102 is a woven fabric. In one or more embodiments, the first fiber substrate 102 may be provided by a preformed substrate, which may be known in the art as a “scrim.” In one or more embodiments, the first fiber substrate 102 comprises fibers of polyester, in particular a polyester bicomponent. Other options for the first fiber substrate exist including both natural and synthetic materials, for example the scrim may be polyester, polyamide, other polyolefins, but is preferably the fibers are of a thermoplastic and preferably a bi-component with a high melt component and a low melt component to facilitate thermal lamination. In one or more embodiments, the material of the fibers for the first fiber substrate 102 is selected to be hydrophobic, having a water contact angle in a range of 100° to 115° as measured according to ASTM D 5725-99. Advantageously, using a hydrophobic material for the fibers of the first fiber substrate 102 allows for the media 100 to dry quickly when purging the captured carbon from the carbon capture particles 104 as will be discussed more fully below.

In one or more embodiments, the fibers forming the fiber substrate have a mean diameter (or mean maximum fiber cross-sectional width if not circular) in a range of 2 μm to 25 μm, more preferably between 5 μm to 15 μm. In one or more embodiments, the fibers forming the fiber substrate have a circular cross-section, but other cross-sectional shapes can also be used. In one or more embodiments, the first fiber substrate 102 has a thickness in a range of 50 μm to 500 μm. In one or more embodiments, the first fiber substrate 102 has a basis weight in a range from 10 gsm (grams per square meter) to 150 gsm, more preferably 15 to 50 gsm. In one or more embodiments, the first fiber substrate 102 has an air permeability in a range from 50 cfm to 1200 cfm, and more preferably 200 to 600 cfm, as measured according to ASTM D737 at a pressure of 125 pascals.

In one or more embodiments, the second fiber substrate 110 may have any of the foregoing properties described above with respect to the first fiber substrate 102, and for example may also be provided by a scrim. In one or more embodiments, the second fiber substrate 110 is the same as the first fiber substrate 102. However, in alternative embodiments, the second fiber substrate 110 is different than the first fiber substrate 102.

In one or more embodiments, the carbon capture particles 104 are any material configured to absorb or adsorb carbon dioxide. In one or more embodiments, the carbon capture particles 104 comprise at least one of amine-based particles, zeolites, silica, alumina, metal oxides, metal-organic frameworks (MOFs), activated carbon, graphite, graphene, fullerene, biochar, or hydrochar, amongst other possibilities. In one or more embodiments, the carbon capture particles 104 have a mean maximum cross-sectional dimension (e.g., diameter) d50 in a range from 0.050 mm to 1.5 mm. Examples of commercially available carbon capture particles 104 suitable for use in embodiments of the disclosed media 100 include Lewatit® VP OC 1065 (Lanxess AG, Cologne, Germany) and Purolite A110 and A500OHPlus (Ecolab Inc., St. Paul, MN). In one or more embodiments, the media 100 includes the carbon capture particles 104 in an amount in a range from 100 gsm to 1500 gsm.

In one or more embodiments, the adhesive layer 106 or beads 108 comprises a hot melt, a curable resin, a pressure sensitive adhesive, or a contact adhesive, amongst other possibilities. In one or more embodiments, the adhesive layer 106 or beads 108 comprise a low-melting polyester, polyamides, or polyolefins, for example. In one or more embodiments, the adhesive layer 106 has a thickness in a range from 50 μm to 200 μm. In one or more embodiments, the adhesive beads 108 have a mean maximum cross-sectional dimension (e.g., diameter) d50 in a range from 1 μm to 250 μm. In one or more embodiments, the media 100 includes the adhesive layer 106 or adhesive beads 108 at 2.5% to 30% by weight of the carbon capture particles 104 (i.e., if the amount of carbon capture particles 104 is 500 gsm, then the amount of the adhesive layer 106 or adhesive beads 108 is about 50 gsm, and hence that is an example of the adhesive being 10% by weight of the carbon capture particles 104).

The carbon capture media 100 is prepared by spreading the carbon capture particles 104 and adhesive layer 106 or beads 108 on the first fiber substrate 102 and then laminating the carbon capture particles 104 to the first fiber substrate 102. In one or more embodiments where the adhesive is an adhesive layer 106, the adhesive layer 106 can be applied to the first fiber substrate 102 by spraying the adhesive onto the first fiber substrate 102 or by unwinding a film of adhesive over the first fiber substrate 102. In one or more embodiments where the adhesive is adhesive beads 108, the adhesive beads can be applied to the first fiber substrate 102 using a particle spreader. In one or more embodiments, the carbon capture particles 104 can also be applied using a particle spreader. In such embodiments, the carbon capture particles 104 may be applied at the same time as the adhesive beads 108; although, in other such embodiments, the carbon capture particles 104 may be applied using a separate particle spreader before or after the adhesive beads 108 are applied.

In one or more embodiments, the carbon capture particles 104 are laminated to the first fiber substrate 102, or between the first fiber substrate 102 and the second fiber substrate 110, at a pressure in a range from about 10 psi to about 70 psi. In one or more embodiments, the carbon capture particles 104 are laminated to the first fiber substrate 102, or between the first fiber substrate 102 and the second fiber substrate 110, at a temperature in a range from about 80° C. to about 250° C. In one or more embodiments, the lamination may be performed in a flatbed thermal laminator.

As described in the foregoing paragraphs, the lamination method may preferably involve (1) spreading carbon capture particles 104 and adhesive beads 108 over the first fiber substrate 102 in one or more layers (for example, these adhesive beads 108 and carbon capture particles may be premixed to provide strata of mixed adhesive/carbon capture particle layers, (2) placing the second fiber substrate 110 over the first fiber substrate 102 such that the carbon capture particles 104 and adhesive bead 108 are disposed therebetween, and (3) laminating the stack of first fiber substrate 102, carbon capture particles 104, adhesive beads 108, and second fiber substrate 110 together using pressure and heat to form the carbon capture media 100.

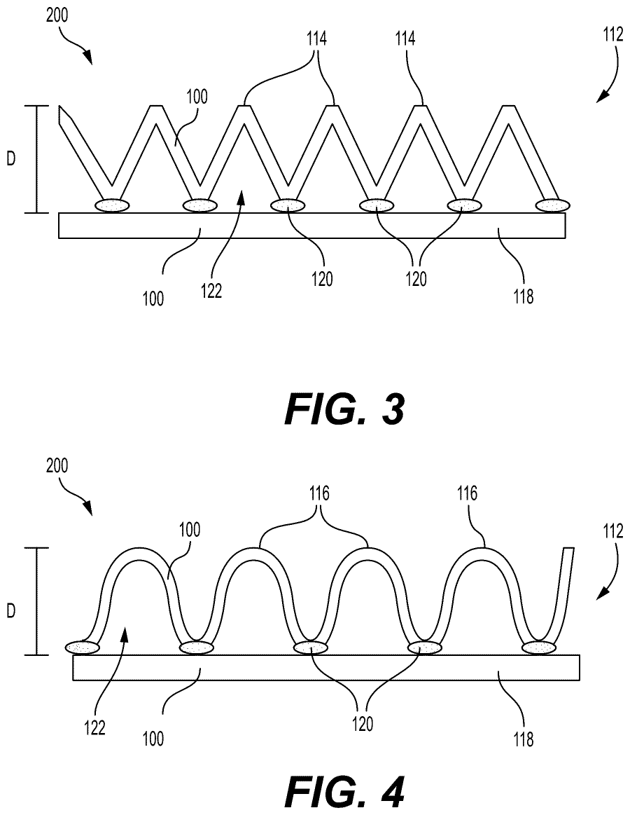

After lamination, the carbon capture media 100 can be embossed, pleated, or embossed and pleated. For example, the carbon capture media 100 can be just embossed to create flow interruptions on the face of the carbon capture media 100 such that a stacked or wound arrangement of the carbon capture media creates 100 a tortuous flow path for air through the media 100. Alternatively, the carbon capture media 100 can be pleated and/or embossed to form flow channels in the form of flutes; and optionally may be additionally embossed at the same time or separately for providing a form of flow interrupter along flutes. FIGS. 3 and 4 depict example embodiments of pleated media 112 formed by pleating and/or embossing that provide flutes.

In one or more embodiments, the carbon capture media 100 is pressed (i.e., pleated or embossed) to form triangular pleats 114 as shown in FIG. 3 or sinusoidal pleats 116 as shown in FIG. 4. In one or more embodiments, the pleats 114, 116 have a depth D in a range from 2 mm to 25 mm. In one or more embodiments, the pleated media 112 includes from 1 pleat per inch to 12 pleats per inch.

In one or more embodiments, the pleated media 112 can be pleated using a blade pleater, pleat scores rolls, a corrugator (e.g. in the case of sinusoidal pleats), and a plate press, or the like. As used herein the term “pleat” is meant to refer to the structure of providing the flow channels (flutes) by folding the media either via corners/folds that may be relative sharp as shown in FIG. 3 or pleating or otherwise pressed via embossing with smooth radiused as shown in FIG. 4; whereas “embossing” and “embossments” may also separately be in reference to additional structures that may be press formed (e.g., via corrugator rolls and/or plate press, additional roll forming, or otherwise) into the porous media wall as protrusions extending transversely into the flow channels and at intermittent locations along the flutes to serve as a flow interrupter to disrupt flow and create turbulence for additional gas diffusion into and out of the porous media, which embossing/embossments may be shallower than the pleat depth.

As used herein, for example as shown in FIG. 4 involving sinusoidal pleats 116, the term pleat(s) is/are also meant to include corrugation(s) as the media of FIG. 4 may be formed by a pair of corrugation rolls that form the media sheet into a plurality of grooves providing flow channels, for example, elongated flutes, which are preferably parallel with each other. Accordingly, pleating as used herein is broad enough term for different types of folds or forming in a manner that resembles folds and as such includes as a possibility corrugating as corrugating also creating folds in the media sheet in the context of this application and claims here where the material appears folded in a way that creates a series of ridges or grooves that may be either sharp or radiused.

As shown in FIGS. 3 and 4, the pleated media 112 is joined to a preferably flat media 118 (which is also carbon capture media 100), e.g., using a glue 120, to form a media sheet 200. In one or more embodiments, the glue is an acrylic adhesive, a polyurethane adhesive, a silane-based adhesive, or an epoxy adhesive, amongst other possibilities. An example of a suitable commercially available adhesive is Loctite® Power Grab Heavy Duty Express (available from Henkel Corporation, Rocky Hill, CT). The combination of the pleats 114, 116 of the pleated media 112 and the flat media 118 define flow-through channels 122 (also known as flutes). The preferably flat media 118 may alternatively also be pleated/embossed.

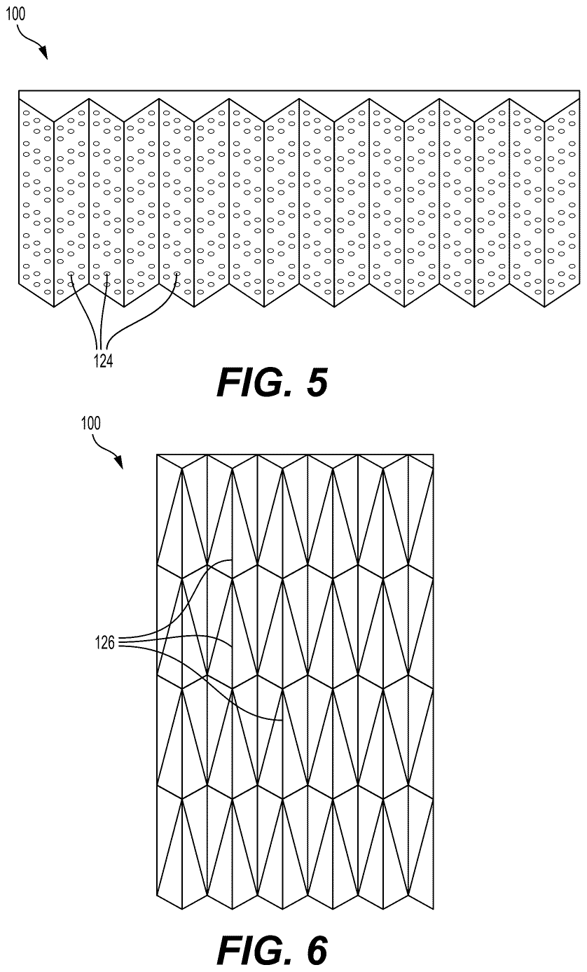

As mentioned, the carbon capture media 100 can be embossed before or during such pleating/embossing to provide flutes, and such embossments can be used as flow interrupters to increase the turbulence of air flow through the channels 122. Either or both of the pleated media 112 and the flat media 118 may be embossed which create embossments that are protrusions as shown in FIG. 5-7 that act as flow interrupters. Such protrusions when formed into the sheet provide a projecting peak/ridge on one side of the sheet and a recess/saddle on the opposing side of the sheet. FIG. 5-7 depict examples of embossing patterns that can be embossed into the carbon capture media 100 that is used for the pleated media 112 and/or the flat media 118 (which flat media 118 alternatively be non-flat and also can have such flow interrupter embossments).

In FIG. 5, the embossing pattern is a plurality of dots 124 to provide the protrusions. The dots 124 can be depressions, bumps, or a combination of both depressions and bumps of various shapes including circles, squares, and teardrops, amongst other possibilities, all of which are protrusions extending transversely to the flow channels (flutes) that are formed by the pleats.

In FIG. 6, the embossing pattern comprises embossment protrusions as a plurality of triangles 126.

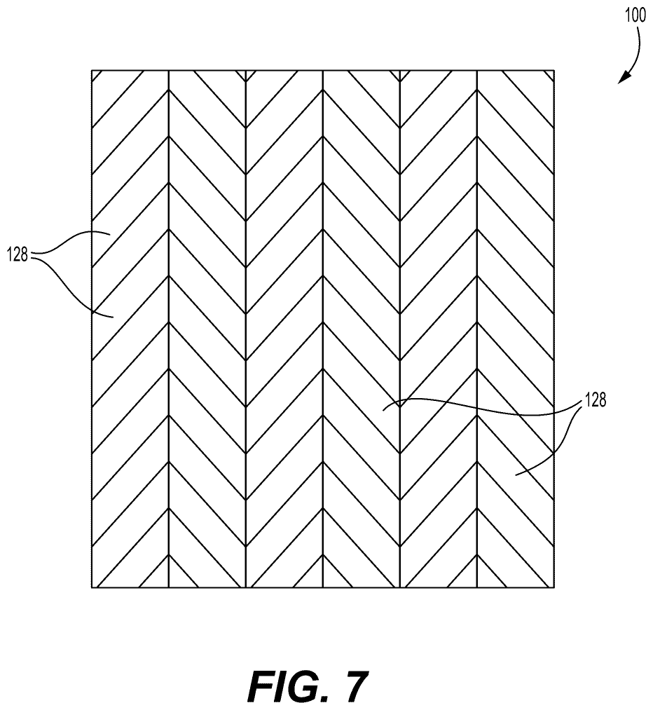

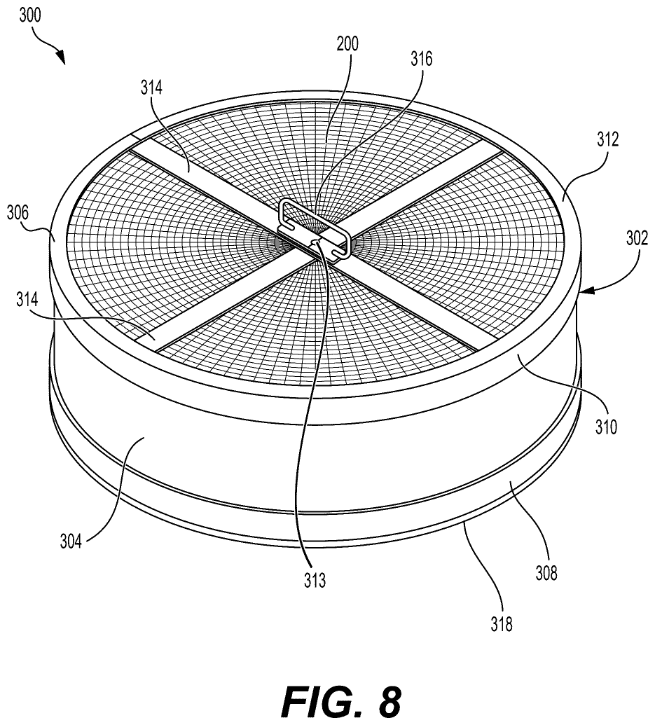

In FIG. 7, the embossing pattern comprises embossment protrusions as a plurality of chevrons 128.

As can be seen in FIGS. 6 and 7, the triangles 126 and chevrons 128 are formed along the pleat length.

As will be discussed more fully below, the increased turbulence of the gas flow creates more contact between the air and the carbon capture media 100, allowing for increased capture of carbon from the air. In one or more embodiments, the embossments may have a depth that is from 0.5 mm up to less than the pleat depth (to avoid cutting off flow through the flow through channels 122).

The media sheet 200 is wound or stacked to form a carbon capture element. Winding or stacking the media sheet 200 will create additional flow through channels 122 as the flat media 118 of one layer of winding or stacking will engage the pleated media 112 of an adjacent layer.

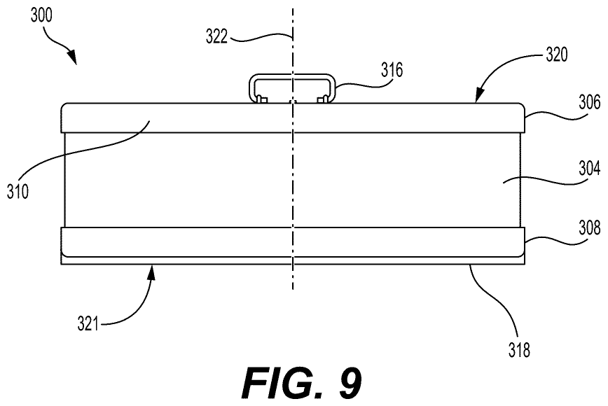

Referring now to FIGS. 8 and 9, the media sheet 200 is wound to form an embodiment of a carbon capture element 300. The wound media sheet 200 is placed within a frame 302, such as a metal frame comprised of, e.g., stainless steel. In one or more embodiments, the frame 302 includes an outer ring 304 disposed between a first cap 306 and a second cap 308. The first cap 306 and the second cap 308 are attached (e.g., welded) to the outer ring 304 to retain the wound media sheet 200 within the frame 302. In one or more embodiments, the wound media sheet 200 is closely matched in size to the outer ring 304, including even slightly compressing the wound media sheet 200 to fit within the outer ring 304. In one or more embodiments, the wound media sheet 200 may be glued to the inner surface of the outer ring 304.

Alternatively, the frame 302 may just comprise the first cap 306 and the second cap 308 glued to the carbon capture element 300 without the outer ring 304. In one or more such embodiments, the outer surface of the carbon capture element 300 between the first cap 306 and the second cap 308 may just be an outer surface of the wound or stacked media sheet 200, such as the flat media 118, for example.

In one or more embodiments, the first cap 306 includes a first outer band 310 with a first inwardly extending lip 312. In one or more such embodiments, the first cap 306 may further include first cross-straps 314 extending diametrically across the first inwardly extending lip 312. In one or more embodiments, the second cap 308 has substantially the same structure as the first cap 306 in that the second cap 308 includes an outer band, an inwardly extending lip, and cross-straps. In one or more embodiments, a bolt 313 extends from the cross straps 314 of the first cap 306 through the wound media sheet 200 to the cross-straps (not shown) of the second cap 308 to provide additional structure to the carbon capture element 300. As shown in FIGS. 8 and 9, the first cap 306 may further include a handle 316 attached to the cross-straps 314, and the second cap 308 may further include a gasket 318 attached to the inwardly-extending lip.

In one or more embodiments, the wound media sheet comprises a first end face 320, which is adjacent to the first cap 306, and a second end face 321, which is opposite to the first end face 320 and adjacent to the second cap 308. Carbon is captured within the wound media sheet 200, and the air with reduced carbon content flows out of the wound media sheet 200. As shown in FIG. 9, the direction of air flow through carbon capture element 300 is along axis 322 from the first end face 320 to the second end face 321 or from the second end face 321 to the first end face 320 (e.g., depending on which direction the carbon capture element 300 is installed within the carbon capture system).

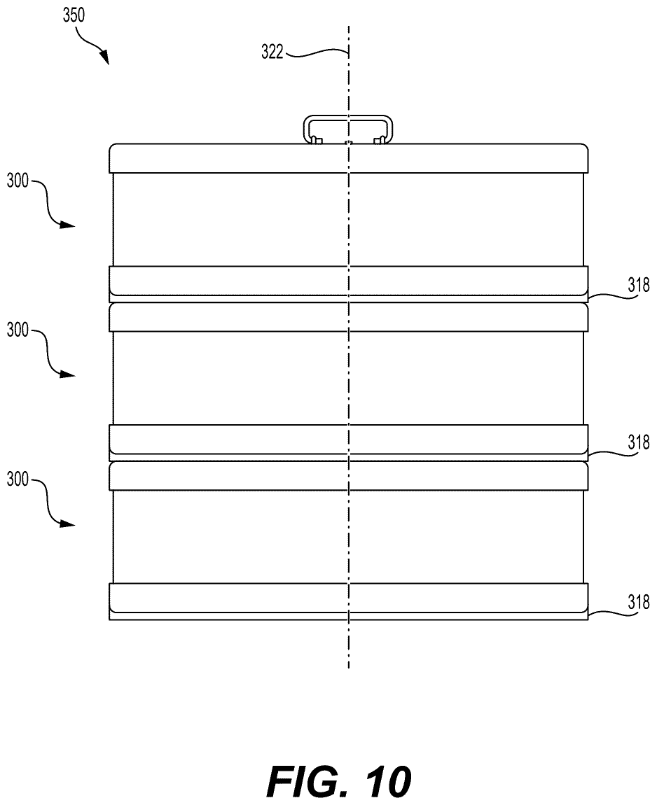

Multiple carbon capture elements 300 can be stacked in a fluidic series in the direction of axis 322 to form a contactor element 350 of a carbon capture system as shown in FIG. 10. In one or more embodiments, multiple (two or more) carbon capture elements 300 can be stacked together to form the contactor element 350. When stacked, the gasket 318 provides a separation distance between adjacent carbon capture elements 300 in a range from 1 mm to 50 mm, preferably from 5 mm to 25 mm. This gap creates an intermediate pressure chamber that can serve as a flow interrupter for the flow channels and serves to help diffuse the gas flow into and out of the porous media. Notwithstanding, the contactor element 350 may include a single carbon capture element 300 if the carbon capture element 300 were sized to fit within the contactor of the carbon capture system. However, in order to provide ease of handling, the depicted embodiment of the contactor element 350 includes three carbon capture elements 300 to facilitate insertion and removal of the carbon capture elements 300 from the contactor of the carbon capture system by an individual. If, for example, a machine were employed that could easily lift one larger carbon capture element 300, the contactor element 350 could instead include just a single carbon capture element 300.

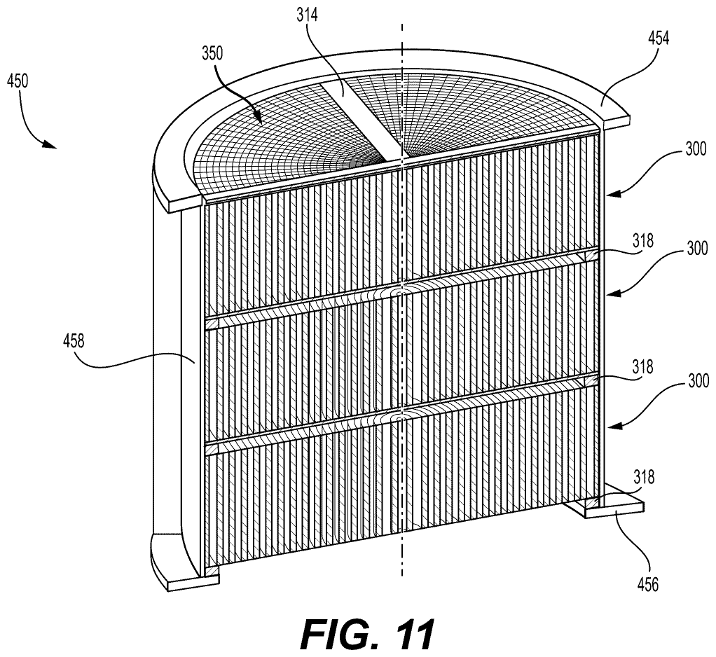

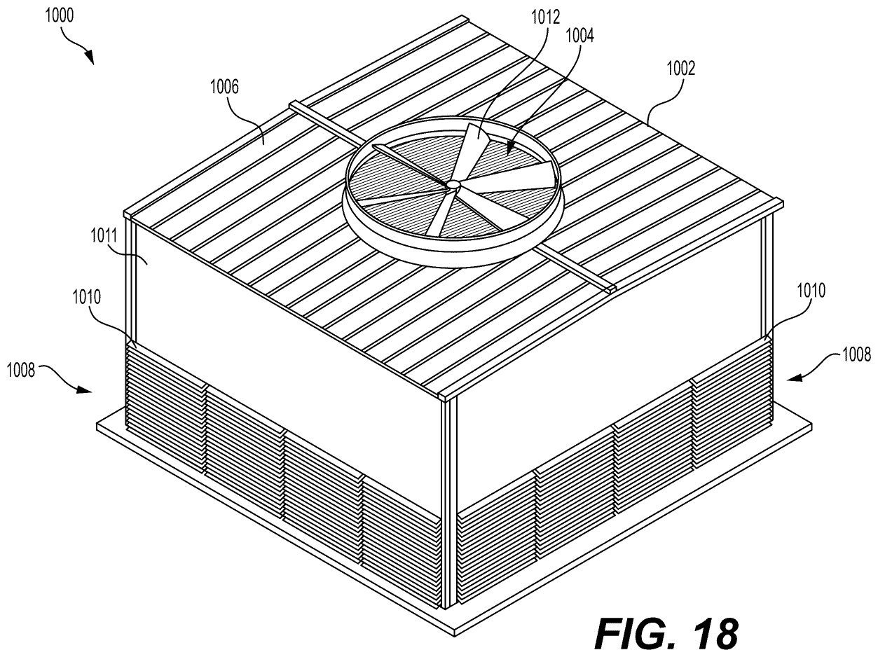

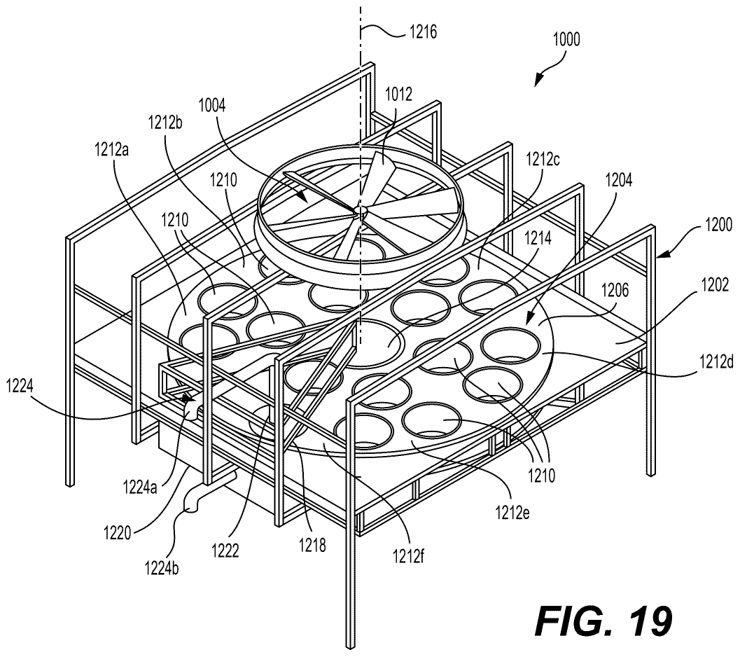

FIG. 11 depicts an embodiment of a contactor housing 450 for a contactor element 350 including three of the carbon capture elements 300. As can be seen in FIG. 11, the housing 450 includes a first flange 454 and a second flange 456 with a sidewall 458 extending between the first flange 454 and the second flange 456. The first flange 454 has an inner edge with a first diameter, and the sidewall 458 has an inner surface also having the first diameter such that the inner surface intersects with the inner edge. The second flange 456 has an inner edge with a second diameter that is less than the first diameter such that the inner edge of the second flange extends inwardly (e.g., by 1 cm to 3 cm, in particular about 2 cm) of the inner surface of the sidewall 458. In this way, the second flange 456 provides an interior ledge or lip that acts as an abutment surface for a first carbon capture element 300. A second carbon capture element 300 can be stacked on the first carbon capture element 300, and a third carbon capture element 300 can be stacked on the second carbon capture element 300. In such embodiments, the gaskets 318 may provide a separation distance between adjacent carbon capture elements 300. In one or more embodiments, the separation distance is in a range from 1 mm to 50 mm, preferably between 5 mm and 25 mm. The contactor housing 450 as described may be used in the carbon capture system 1000, in particular in the carbon capture cells 1210, of FIGS. 18 and 19 (discussed more fully below).

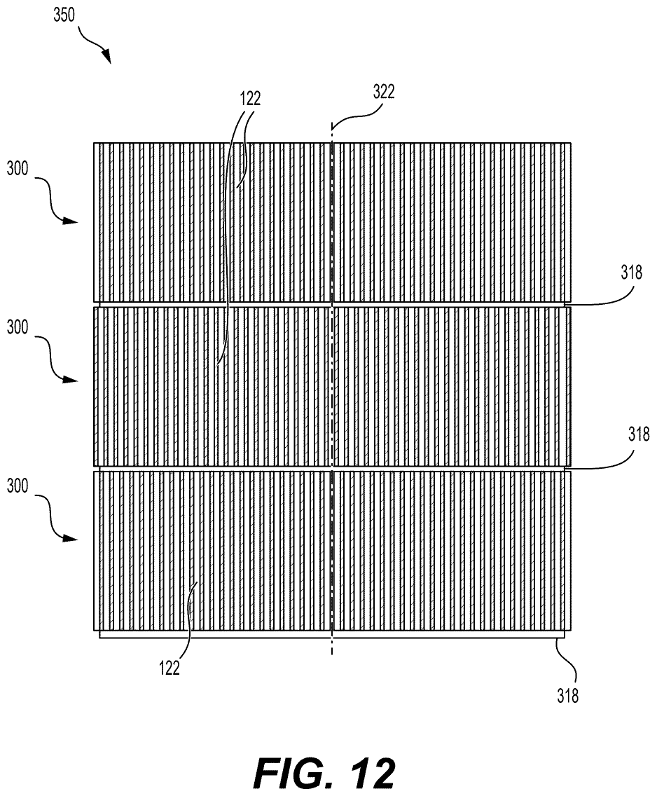

In order to enhance the carbon capture efficiency of the contactor elements 350, the wound media sheets 200 of the carbon capture elements 300 can be arranged to increase the turbulence of air flow between the carbon capture elements 300. FIGS. 12-17 depict various embodiments of stack arrangements for the carbon capture elements 300 that provide such increased turbulence by providing a tortuous path for the flow of air through the fluidic series of carbon capture elements.

In the embodiment depicted in FIG. 12, the carbon capture elements 300 are arranged such that flow-through channels 122 of the wound filter media 200 are axially offset or misaligned. In one or more embodiments, the flow-through channels 122 can be axially offset by rotating the carbon capture elements 300 relative to one another. For example, the flow-through channels 122 may be axially offset by one half of the pleat depth. Given the number of flow-through channels 122 in the carbon capture elements 300, not all of the flow-through channels 122 may be axially offset, but in one or more embodiments, at least half, in particular at least 60%, and most particularly at least 70%, of the flow-through channels 122 are axially offset to at least some degree. In one or more embodiments, the carbon capture elements 300 can be axially offset by providing a keyed feature between a housing of the contactor element 350 and the carbon capture elements 300 to provide a desired angular orientation of each carbon capture element 300 relative to the other carbon capture elements 300, thereby providing a form of flow interrupter.

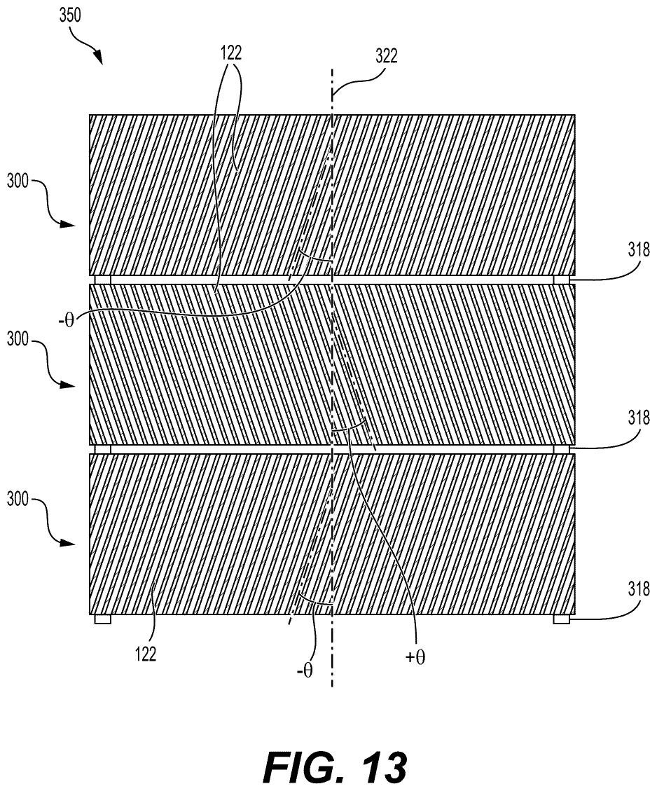

In the embodiment depicted in FIG. 13, the carbon capture elements 300 include flow-through channels 122 that are arranged at alternating angles θ relative to the axis 322 also provide a form of flow interrupter. In one or more embodiments, the flow-through channels 122 are angled at 45° or less, in particular 30° or less, and most particularly 15° or less, with respect to the axis 322. In one or more embodiments, the flow-through channels 122 of a first carbon capture element 300 are arranged at a negative angle (−θ) relative to the axis 322, and the flow-through channels 122 of a second carbon capture element 300 are arranged at a positive angle (+θ) relative to the axis 322. The flow-through channels 122 of a third carbon capture element 300 are then arranged at a negative angle (−θ) relative to the axis 322. In this way, the alternating angles of the flow-through channels 122 increase the turbulence of the air flow through the contactor element 350.

In one or more embodiments, the carbon capture elements 300 can be prepared by pleating the media 100 at an angle and winding the filter media sheet 200 for adjacent carbon capture elements 300 in different directions. For example, one carbon capture element 300 can be pleated at the angle (θ), positive or negative, and wound clockwise, and then an adjacent carbon capture element 300 can be pleated also at the angle (θ) and wound counter clockwise. This would produce carbon capture elements 300 having a negative angle (−θ) relative to the axis 322 and a positive angle (+θ) relative to the axis 322. In one or more other embodiments, the carbon capture element 300 can be made oversized, containing straight pleats relative to the axis 322, and the flow faces of the oversized carbon capture element 300 can be trimmed at an angle such that the flutes will be angled at the angle (θ) when the flow faces are made perpendicular to the axis 322.

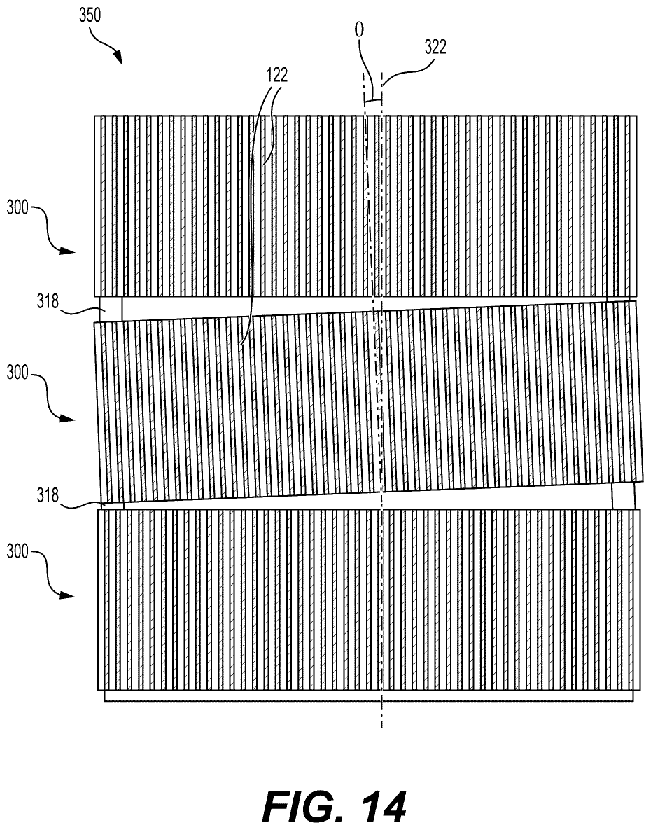

In the embodiment depicted in FIG. 14, the carbon capture elements 300 are stacked in an angled configuration. Within a contactor element 350, at least one of the carbon capture elements 300 is held at an angle θ relative to the flow axis 322. In one or more embodiments, the angle θ relative to the flow axis 322 is in a range from 1° to 45°, in particular in a range from 1° to 10°. In one or more embodiments, the carbon capture elements 300 can be angled using gaskets 318 with asymmetrical thicknesses (e.g., having a thickest side diametrically opposed to a thinnest side of the gasket 318). In one or more other embodiments, the flow faces of the carbon capture elements 300 can be trimmed such that the flow faces are not perpendicular to the axis 322. within the housing 450 of the contactor element 350 or by utilizing angled gaskets 318, 406 that tilt the carbon capture elements 300 off of the axis 322 when stacked (as shown in FIG. 14).

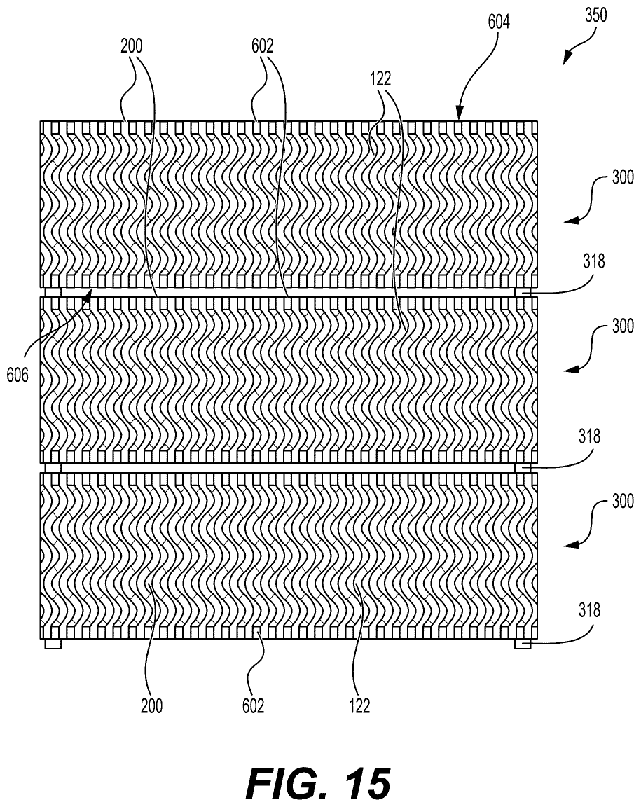

In the embodiment depicted in FIG. 15, the stacked or wound filter sheet 200 includes wavy pleats 602 extending across the width of the media sheet 200 from an inlet face 604 to an outlet face 606 of each carbon capture element 300, 400. In this way, the combination of wavy pleats 602 and flat media define the flow-through channels 122 that curve back and forth from the inlet face 604 to the outlet face 604. Advantageously, the wavy path of the flow-through channels 122 increases the contact time for the air to flow through the carbon capture element 300 without substantially increasing the pressure drop across the carbon capture element 300. Further, while FIG. 15 is discussed in terms of a wound filter sheet 200, the carbon capture element 300 may instead be formed from a stack of media sheets 200.

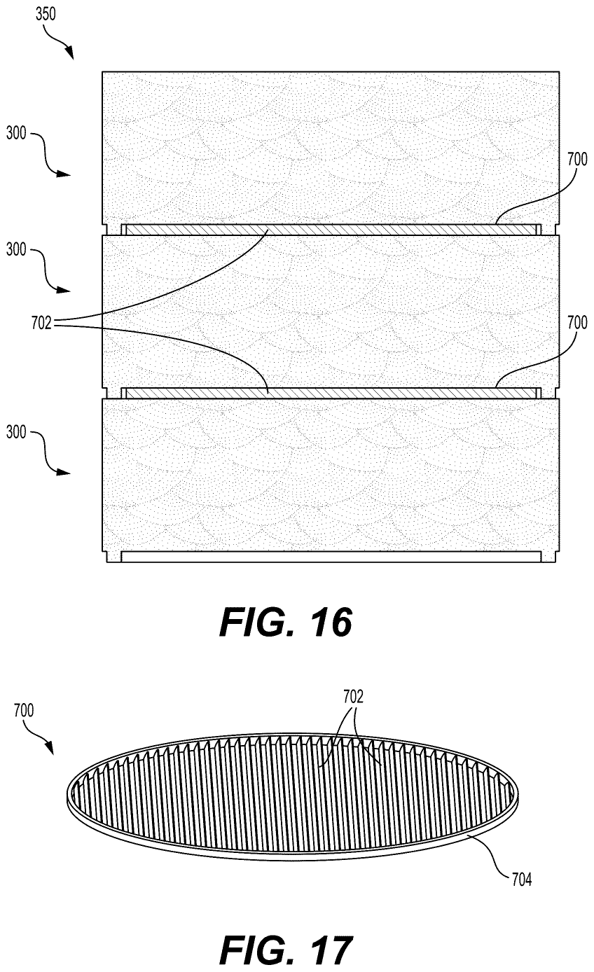

FIG. 16 depicts an embodiment in which the carbon capture elements 300 of a stack of carbon capture elements 300 are separated by a screen 700 having angled vanes 702. The carbon capture elements 300 may have flow-through channels as described above in relation to any of FIGS. 12-15, or the carbon capture elements 300 can have straight flow-through channels 122 that are axially aligned. In any case, the screen 700 with angled vanes 702 redirects air flowing between the carbon capture elements 300 so as to create turbulence when moving from one carbon capture element 300 to the next in a contactor 350. As shown in FIG. 16, a first screen 700 may direct air flowing between a first and a second carbon capture element 300 in a first direction, and a second screen 700 may direct air flowing between the second and a third carbon capture element 300 in an opposite direction.

FIG. 17 depicts a perspective view of an example embodiment of a screen 700. As can be seen, the screen 700 includes an outer hoop 704 disposed within a first plane, and the angled vanes 702 extend across the hoop 704. Each vane 702 is disposed in a plane that is transverse to the first plane of the outer hoop 704. In one or more embodiments, the vanes 702 are disposed at an angle in a range from −90° to 90°, in particular in a range of 45° to 60° (or −45° to −60°), with respect to the first plane of the outer hoop 704.

FIG. 18 illustrates an embodiment of a carbon capture system 1000, which is, in particular, a direct air capture system. The carbon capture system 1000 includes an outer housing structure 1002 with one or more inlet openings 1004 through a side of the housing structure 1002, such as the roof 1006. Further, the carbon capture system 1000 includes one or more outlet openings 1008. In the embodiments depicted in FIG. 18, the outlet openings 1008 are louvres 1010 formed in walls 1011 of the housing structure 1002. A fan 1012 positioned in each of the one or more inlet openings 1004 directs a gas stream, in particular air from the surrounding environment, through the one or more inlet openings 1004 into the outer housing structure 1002, and as will be discussed more fully below, carbon dioxide is captured from the air within the outer housing structure 1002 and output through the outlet openings 1008. In this way, the concentration of carbon dioxide in the gas stream (environmental air) exiting the carbon capture system 1000 is less than the concentration of carbon dioxide in the gas stream entering the carbon capture system 1000.

FIG. 19 provides a perspective view of the internal structure of the carbon capture system 1000 within the outer housing structure 1002. Disposed within the outer housing structure 1002 is a frame 1200 holding a platform 1202. Disposed on the platform 1202 is a rotating carrier structure 1204 having a first (upper) plate 1206 and a second (lower) plate (not shown). Disposed between the first plate 1206 and second plate are a plurality of carbon capture cells 1210. The first plate 1206 and the second plate may be divided into sections 1212, and in the embodiment show in FIG. 19, there are six sections 1212a-1212f. Further, in the embodiment shown, each section 1212a-1212f includes three carbon capture cells 1210. The rotating carrier structure 1204 rotates about an armature 1214 extending on central axis 1216. During operation, the fan 1012 draws air into the direct air carbon capture system 1000, forcing it through the carbon capture cells 1210 of the rotating carrier structure 1204. In particular, the platform 1202 and rotating carrier structure 1204 are sealed to each other and to the outer housing structure 1002 in such as way that the air entering the carbon capture system 1000 must flow through the carbon capture cells 1210 to exit the carbon capture system 1000. The carbon capture cells 1210 may each include a contactor housing 450 (e.g., as described above in relation to FIG. 11), and contactor elements 350 (e.g., as described above in relation to any of FIGS. 8-10 and 12-17) may be provided in the contactor housings 450 to absorb or adsorb the carbon dioxide from the gas stream, removing it from the gas stream.

During operation, the sections 1212a-1212f of the rotating carrier structure 1204 pass between an upper arm 1218 and a lower arm 1220. The upper arm 1218 and lower arm 1220 each include a plurality of lids 1222 corresponding to the number of carbon capture cells 1210 of each section 1212a-1212f of the rotating carrier structure 1204. The lids 1222 are lowered to seal the carbon capture cells 1210 against the flow of air through the carbon capture cells 1210. Further, each lid 1222 of the upper arm 1218 and the lower arm 1220 is connected to a steam conduit 1224. As shown in FIG. 19, the upper arm 1218 includes an inlet steam conduit 1224a connected to its lid or lids 1222, and the lower arm 1220 includes an outlet steam conduit 1224b connected to its lid or lids (not shown). Steam flows through the inlet steam conduit 1224a into the carbon capture cells 1210 to release the captured carbon dioxide from contactors 350 of the carbon capture cells 1210 and out of the carbon capture cells 1210 into the outlet steam conduit 1224b. The released carbon dioxide is carried by the outlet steam conduit 1224b downstream for further processing in which the carbon dioxide and steam are separated and the carbon dioxide is stored without being released back into the atmosphere. Thus, as the carbon capture cells 1210 reach their carbon capture capacity, the carbon capture cells 1210 are exposed to steam to remove the captured carbon dioxide so that the carbon capture cells 1210 can continue to capture additional carbon dioxide from the gas stream.

This example of a carbon capture system 1000 is merely exemplary. Additional description of a carbon capture system 1000 of this type can be found in International Publication No. WO2024/088859A1, “System for Direct Air Capture of Carbon Dioxide,” published on May 2, 2024, the entire contents of which are incorporated herein by reference thereto. Other types of carbon capture systems 1000 are compatible with the present disclosure.

In one or more embodiments in which the gas stream is ambient air, the concentration of carbon dioxide in the air may be in a range of about 300 ppm to 500 ppm. Further, in one or more such embodiments, the concentration of carbon dioxide in the ambient air that has flowed through the contactor 350 is 10 ppm or less, in particular 0 ppm.

### EXAMPLE

A carbon capture element 300 according to the present disclosure was constructed as described below. The filter media was prepared from a first scrim 102 of nonwoven polyester bicomponent fiber having a fiber diameter of about 25 μm, and the first scrim 102 had a thickness of about 150 μm. The first scrim 102 had a basis weight of 40 gsm and an air permeability of 600 cfm as measured according to ASTM D737 at a pressure of 125 pascals. Ion exchange resin Lewatit® VP OC 1065 (primary amine chemistry) was used as the carbon capture particles 104 in an amount of 500 gsm. The carbon capture particles 104 had a particle size of 0.3 mm to 1.25 mm. The adhesive was adhesive beads 108 of low melting polyester having a particle size of 80 μm to 200 μm. The adhesive beads 108 were applied in amount of 10% by weight of the carbon capture particles 104. The adhesive beads 108 and carbon capture particles 104 were applied to the first scrim 102 using a particle spreader. A second scrim 110 having the same properties as the first scrim 102 was positioned over the first scrim 102 having the carbon capture particles 104 and adhesive beads 108 applied thereon.

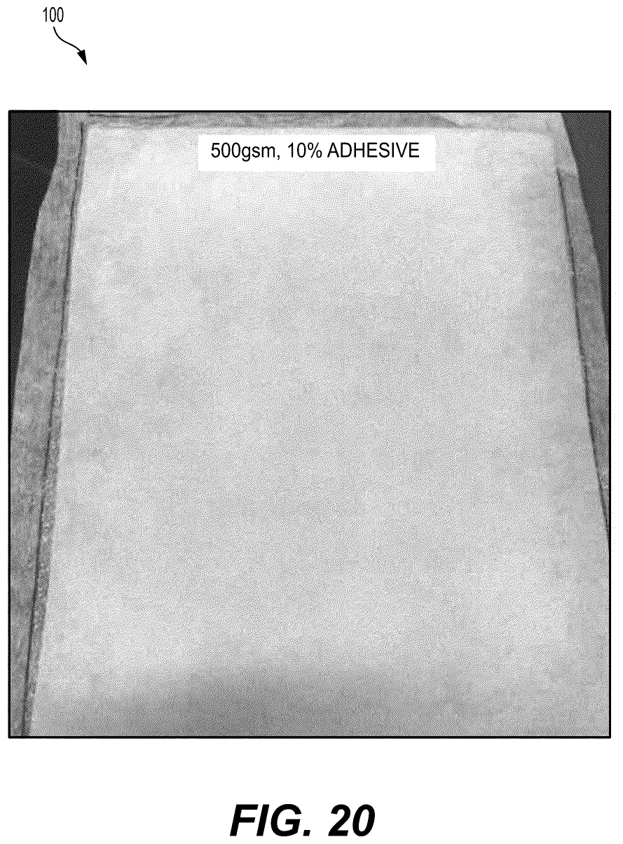

The first scrim 102, carbon capture particles 104, adhesive beads 108, and second scrim 110 were laminated using a flatbed thermal laminator at a lamination pressure of 75 psi, a temperature of about 150° C., and a speed of 5 ft/min to produce the carbon capture media 100, which is shown in FIG. 20. The carbon capture media 100 had a thickness of about 1.7 mm and an air permeability of 175 cfm.

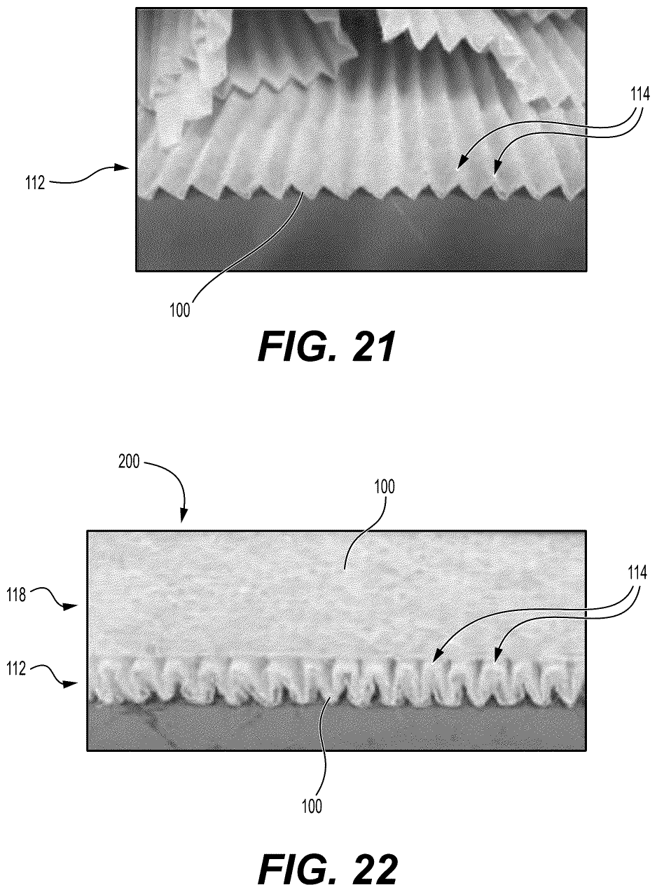

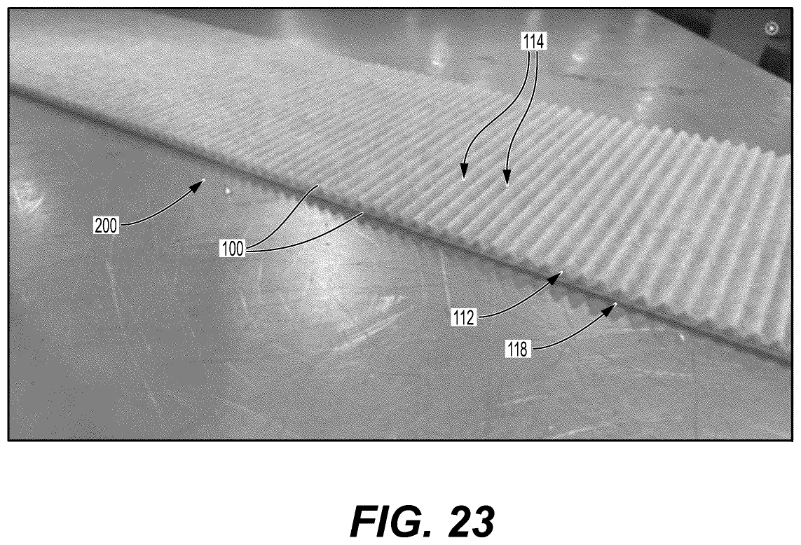

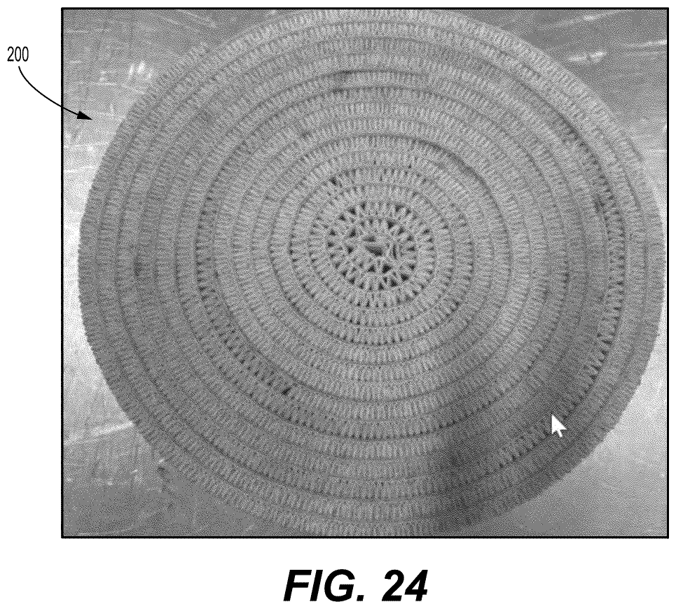

The carbon capture media 100 was then pleated to form a pleated media 112 using a blade pleater to produce triangular pleats 114 as shown in FIGS. 21 and 22. The pleats 114, 116 each had a pleat depth of 6 mm, and there were four pleats per inch. A flat media 118 was glued to the pleated media 112 using a silane adhesive as shown in FIGS. 22 and 23 to form a media sheet 200. The media sheet 200 was then wound to form a cylindrical, tangential flow carbon capture element having a diameter of about 24 inches and a height of 8 inches as shown in FIG. 24. The wound media sheet was placed in a stainless steel (type 304) frame (such as shown in FIGS. 8 and 9), and an EPDM gaskets 318 was attached to the frame.

The carbon capture element 400 so constructed contained 158 grams of carbon capture particles 104 per liter and had a fill factor in the range of 60% to 70% (i.e., percentage of volume of the carbon capture element 400 occupied by solid components), thereby providing 30% to 40% of void space for flow of the gas stream. Additionally, during testing, Applicant found that the presently disclosed carbon capture element 400 exhibited faster drying times when purging the captured carbon using pressurized steam. That is, the disclosed carbon capture element 400 required less down time during operation.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A media for capturing carbon dioxide from a gas stream of ambient air, the media comprising:
a first fiber substrate; and
carbon capture particles attached to the first fiber substrate, the carbon capture particles being formed from one or more materials capable of capturing carbon dioxide through absorbance or adsorbance.

2. The media of claim 1, further comprising an adhesive, wherein the adhesive attaches the carbon capture particles to the first fiber substrate.

3. The media of claim 2, wherein the adhesive comprises adhesive beads and/or an adhesive layer.

4. The media of claim 2, wherein the adhesive and the carbon capture particles are pre-mixed with adhesive that is spread upon the scrim as at least one mixed layer.

5. The media of claim 2, wherein the adhesive comprises bi-component and the adhesive and the carbon capture particles are thermally laminated to the first fiber substrate.

6. The media of claim 2, wherein the adhesive is provided in 2.5% to 30% by weight of the carbon capture particles.

7. The media of claim 1, comprising 100 gsm to 1500 gsm of the carbon capture particles.

8. The media of claim 1, wherein the carbon capture particles comprise a maximum cross-sectional dimension in a range from 0.050 mm to 1.5 mm.

9. The media of claim 1, wherein the carbon capture particles comprise at least one member of the following group: amine-based particles, zeolites, silica, alumina, metal oxides, metal-organic frameworks (MOFs), activated carbon, graphite, graphene, fullerene, biochar, and/or hydrochar.

10. The media of claim 1, wherein the first fiber substrate is a nonwoven fabric, the first fiber substrate comprising fibers of polyester, polyamide, a polyolefin and/or other thermoplastic material; and wherein at least some of the fibers preferably include a polyester; and wherein at least some of the fibers preferably are bi-component facilitating thermal lamination.

11. The media of claim 1, wherein the first fiber substrate comprises one or more of the following characteristics:
(a) the fibers forming the first fiber substrate have a diameter in a range of 2 μm to 25 μm;
(b) a thickness in a range of 50 μm to 500 μm;
(c) a basis weight in a range from 10 gsm to 150 gsm; and/or
(d) air permeability in a range from 50 cfm to 1200 cfm as measured according to ASTM D737.

12. The media of claim 1, wherein the fibers forming the first fiber substrate are hydrophobic having a water contact angle in a range from 100° to 115° as measured according to ASTM D5725-99, thereby providing the media with a quick dry property.

13. The media of claim 1, further comprising a second fiber substrate, wherein the carbon capture particles are laminated between the first fiber substrate and the second fiber substrate.

14. The media of claim 1, comprising a plurality of pleats and/or embossments forming flow channels.

15. The media of claim 14, wherein the plurality of pleats are triangular pleats or sinusoidal pleats having a pleat depth in a range from 2 mm to 25 mm.

16. The media of claim 1, comprising embossing.

17. The media of claim 16, wherein the embossing comprises at least one of a plurality of dots, a plurality of triangles, a plurality of chevrons, or a plurality of wavy lines.

18. A carbon capture media sheet, comprising:
a first media that is pleated and/or embossed; and
a second media that is flat and/or embossed, the second media being bonded to the first media so as to define a plurality of flow-through channels;
wherein at least one of and preferably both of the first media and the second media comprise the media according to claim 1.

19. A carbon capture element, comprising a plurality of the carbon capture media sheets of claim 18 arranged in a stack.

20. A carbon capture element, comprising the carbon capture media sheet of claim 18 wound into a cylinder.

21. The carbon capture element of claim 20, further comprising a frame, the frame comprising:
an outer ring surrounding the stacked or wound carbon capture media sheet;
a first cap disposed at a first end of the outer ring; and
a second cap disposed at a second end of the outer ring opposite to the first end.

22. The carbon capture element of claim 21, further comprising a gasket extending from the second cap.

23. A contactor, comprising:
one or more carbon capture elements according to claim 19.

24. The contactor of claim 23, comprising at least two carbon capture elements being stacked in an axial direction.

25. The contactor of claim 24, wherein at least 50% of the flow-through channels of adjacent carbon capture elements of the at least two carbon capture elements are offset in the axial direction.

26. The contactor of claim 24, wherein the at least two carbon capture elements comprise a first carbon capture element and a second carbon capture element, wherein the flow-through channels of the first carbon capture element are arranged at a negative angle relative to the axial direction, and wherein the flow-through channels of the second carbon capture element are arranged at a positive angle relative to the axial direction.

27. The contactor of claim 24, wherein at least one of the at least two carbon capture elements comprises an inlet flow face defining a plane that is transverse to the axial direction of stacking.

28. The contactor of claim 24, further comprising a screen disposed between each carbon capture element of the at least two carbon capture elements, the screen comprising:
an outer hoop; and
a plurality of vanes extending across the outer hoop;
wherein the outer hoop is disposed in a first plane and each vane of the plurality of vanes is disposed in a plane that is transverse to the first plane.

29. The contactor of claim 23, comprising three carbon capture elements.

30. A method of reducing a concentration of carbon dioxide in a gas stream, comprising:
flowing the gas stream having a first concentration of carbon dioxide through the contactor of claim 23 from a first side to a second side; and
adsorbing or absorbing carbon dioxide in the media such that a second concentration of the carbon dioxide on the second side of the media is less than the first concentration of carbon dioxide on the first side of the media.
